(19) United States
(12) Patent Application Publication
(10) Pub. No.: US 2019/0383315 A1
(43) Pub. Date: Dec. 19, 2019

(54) COMPRESSION LIMITER FASTENER ASSEMBLY

(71) Applicant: General Fasteners Company, Livonia, MI (US)

(72) Inventors: Victor Lanni, Ray, MI (US); Jorge E. Gonzalez, Canton, MI (US); Brian Krawczak, Macomb, MI (US)

(21) Appl. No.: 16/010,963

(22) Filed: Jun. 18, 2018

(51) Int. Cl. F16B 5/02; F16B 41/00

(52) U.S. Cl. CPC F16B 5/025; F16B 41/002

(57) ABSTRACT

A compression limiter fastener assembly for assembling a first assembly member to a second assembly member has fastener element with a drive head and a shank portion extending from the drive head to a point section. The shank has a non-threaded portion proximate to the drive head and a distal threaded portion positioned at a distal portion of the shank opposite from the drive head. A sleeve element has a tubular section with a bore therethrough sized to surround the threaded end portion and the non-threaded portion of the shank with clearance to allow the shank to be laterally movable in the bore. The sleeve element has at least one radially inwardly extending tab engaging the shank such that the threaded section is axially retained within the confines of the bore namely within the axial extent of the sleeve element until final installation.

### TECHNICAL FIELD

This invention relates to a compression limiter fastener assembly that includes a threaded fastener element and a compression limiter

### BACKGROUND OF THE DISCLOSURE

Often two assembly members are fastened together with a fastener element. For example, fastener elements have long been used to assemble parts of an automotive engine and other components together. A non-threaded hole is in the first assembly member and a threaded hole is machined in a second assembly member. For example, an intake manifold or oil pan may be the first assembly member and an engine block with threaded holes may be the second assembly member.

A threaded fastener with a head passes through the non-threaded hole and threadedly engages the threaded hole. The head on a washer engages the first assembly member about the non-threaded hole to retain the first and second assembly members together. While engines of the past had engine blocks of iron-based metals, typical engine blocks today have major portions made from aluminum which is substantially lighter than iron but on the other hand is also softer than iron and more prone to scratching. Furthermore, todays engines often use high compressions during the engine cycle, so it is critical that there is no leakage of air or combustion products from the cylinder and other critical components of the engine. Sealing surfaces of the engine need to be scratch free and the sealing gaskets cannot be over compressed due to over tightening, otherwise leakage may occur which would undesirably lower the end compression ratio of the engine. These aspects of todays engine place additional requirements that a fastener must address.

Furthermore, other assembly members or parts installed to the engine, for example oil pan covers and intake manifolds are more commonly made from reinforced plastic material. The use of plastic material provides a manufacturing tolerance stack up due to the inherent characteristic of the injection or other molding techniques used to make the plastic part. The thermal cooling and molding processes are not as precise as the machining of an aluminum engine block and as such certain misalignment of the holes used to install the assembly members together may occur. By today's standards, typically acceptable misalignment of a hole in a plastic part may be up to 2 mm relative to a corresponding hole in an engine block. One can spend great time and effort in eliminating these manufacturing tolerances in large and expensive members, but it is more expeditious to have a less expensive fastener assembly built to accommodate the manufacturing tolerances in the larger parts that may result in potential partial misalignment in the holes in the large parts.

Furthermore, due to the nature of certain assembly members made from plastic material, a compression limiter must be used with the fastener element to prevent excessive tightening force from otherwise cracking or otherwise exerting a compression set into the plastic material which can compromise the sealing gasket effectiveness between the two assembly members. These compression limiters must be made from material that can withstand the severe thermocycles that occur in a nearby engine block. Presently, known commercially available elastomers cannot durably survive the thermocycle issues presented by a nearby engine block. Most compression limiters in this environment are thereby made from metal material.

Furthermore, a preload range of any sealing member between the two assembly members need to be between a yielding point at the high end of the range and a separation point at the low end of the range. A spring member, commonly being a spring washer, may be used to keep the desirable preload range between the high and low points and also compensate for slackening of the plastic and other materials of the two assembled members when fastened together. The spring member can take into account the settlement of the material, particularly any elastomeric and plastic material.

In addition, many fasteners are assembled by machines or robots. The present state of art in robotics desires that the drive head is in an axially predetermined position to allow the robot to easily engage and then tighten the drive head to fasten the fasten assembly in place. This predetermined position makes it important to position the threaded fastener element relative to the compression limiter before installation of the compression limiter in the hole of the first assembly member. The compression limiters have often taken the form of a sleeve which also protects the threads on the fastener element from damage during shipment and handling.

What is a desired is a compression limiter fastener assembly that can be expeditiously made and provide for high thermal cycles, compensate for manufacturing tolerances in the assembly parts, limit compression on any plastic assembly member and any interposed gasket or sealing member, and reduce the risk of a point of a threaded fastener from scratching critical surfaces on an assembly member during installation. What is also desired is a fastener element that can be axially preset in position in a compression limiter that protects the threads and be captive in the compression limiter even when exposed to normal shipping and handling until installation.

### SUMMARY OF THE DISCLOSURE

In accordance with one embodiment of the invention, a compression limiter fastener assembly for assembling a first assembly member to second assembly member has a fastener element with a drive head and a shank extending from the drive head having a non-threaded body portion proximate to the drive head and a distal threaded portion positioned at a distal portion of the shank opposite from the drive head. The drive head is constructed to be engageable to a drive tool for actuating fastening of the fastener assembly. A sleeve element has a tubular section with a bore therethrough sized to surround the threaded portion and the non-threaded body portion of the shank with clearance about the shank to allow the shank to be laterally movable in the bore. Preferably the bore is circular in cross-section and the lateral clearance allows 360° of movement. The sleeve element has at least one radially inwardly extending tab engaging the shank such that the threaded section is axially retained within the confines of the bore within the axial extent of the sleeve element for protection until installation of the fastener element to the first and second assembly member.

The sleeve is constructed to fit within a hole of the first assembly member. The sleeve is axially dimensioned to fully extend through the hole in the first assembly member to function as a compression limiter for the first assembly member. The at least one tab is disengageable from the shank upon sufficient axial force during installation to allow the threaded section to move through the bore and engage a threaded hole in the second assembly member. This disengagement may be caused by the tabs being flexible. Alternatively, the tabs may threadably engage the shank and the shank can rotate to axially move into place.

A load distribution element is located between the drive head and the first assembly member to distribute compressive loads from the drive head to the first assembly member. In one embodiment, the load distribution element is a spring member element seated under a bearing surface of the drive head. In another embodiment, the load distribution element is a collar integrally formed with the sleeve and extending radially outwardly at one end of the sleeve element to be interposed between the bearing surface of the drive head and the first assembly member. The sleeve member and at least one tab is made from a metal wherein the tabs are integrally formed with the sleeve from a punch operation which may include a cold upset. In one embodiment, the at least one tab is a plurality of tabs that are equally circumferentially spaced about the sleeve.

Preferably, the shank has a groove circumferentially extending about the shank that is axially positioned between the drive head and the threaded portion for receiving the at least one tab to retain the portion of the shank axially set relative to the sleeve until installation. Alternately, the at least one tab engages one of the threaded section or the groove in the shank for retaining the axial position of the shank relative to the sleeve wherein the point of the threaded fastener is retained within the axial confines of the sleeve until installation.

### BRIEF DESCRIPTION OF THE DRAWINGS

Reference now is made to the accompanying drawings in which:

FIG. 1 is side elevational view of a compression limiter fastener assembly in accordance with one embodiment of the invention;

FIG. 2 is a cross-sectional view taken along the lines 2-2 shown in FIG. 1;

FIG. 3 is a cross-sectional view taken along the lines 3-3 shown in FIG. 1 showing the compression limiter fastener assembly positioned in a first assembly member and ready to be installed to the second assembly member;

FIG. 4 is a view similar to FIG. 3 showing the compression limiter fully installed to connect the first assembly member to the second assembly member;

FIG. 5 is a sectional view of an alternate embodiment showing the compression limiter positioned in a first assembly member and ready to be installed to the second assembly member; and

FIG. 6 is a view similar to FIG. 5 showing the compression limiter fully installed to connect the first assembly member to the second assembly member.

### DETAILED DESCRIPTION OF THE PREFERRED EMBODIMENT

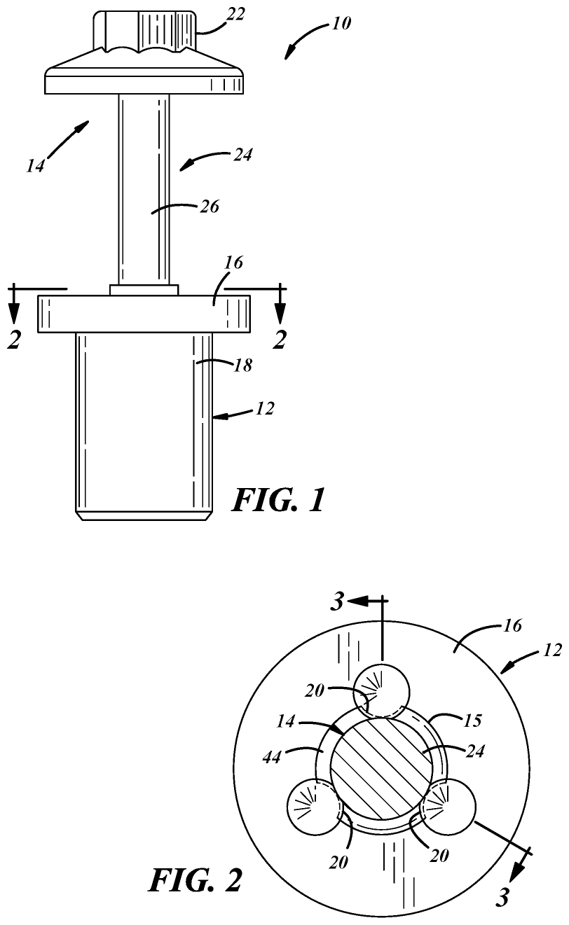

Referring now to FIG. 1, a compression limiter fastener assembly 10 includes a sleeve 12 and a threaded fastener member 14. The compression limiter fastener assembly is preferably made from a suitable metal material that can withstand thermal cycles in the environment near or adjacent an internal combustion engine. As shown in FIG. 2, the sleeve has a central aperture 15 (or bore) and a flange (or collar) 16 at one end that radially extends outward from the main portion 18 of the sleeve. The one end with the collar has three radially inwardly extending tabs 20 that intrude into the central aperture 15. These tabs 20 can be formed by a punch press and are dimensioned to have some flexibility to disengage from the fastener member 14 as explained below.

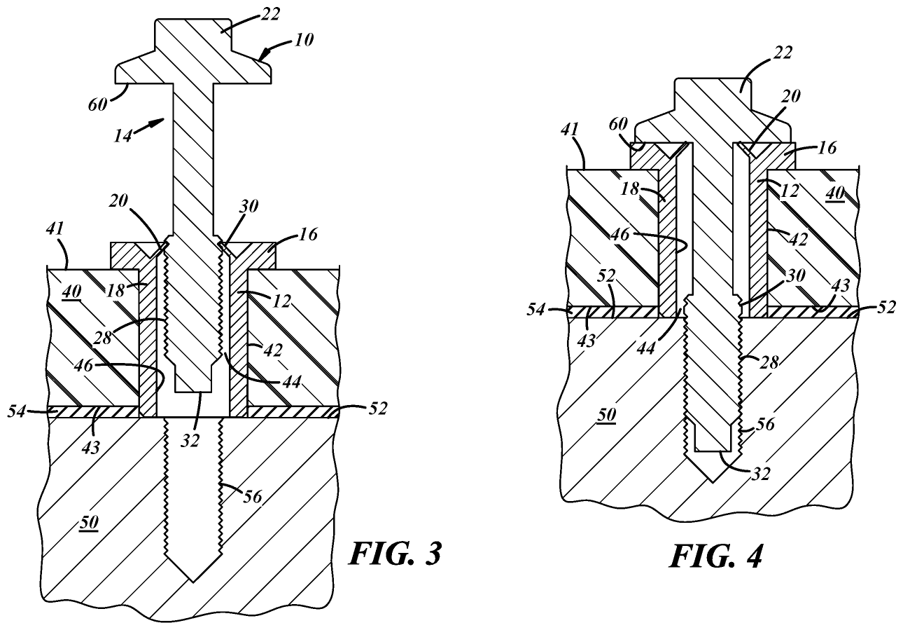

The fastener 14 has a drive head 22, shank 24 that includes a non-threaded body 26 and a distal threaded portion 28 as more clearly shown in FIGS. 3 and 4. A groove 30 is interposed between the body 26 and threaded portion 28. The shank is radially dimensioned to have its groove 30 receive the tabs 20. The tabs when received in the groove 30 will axially affix the fastener member 14 to the sleeve 12 and be resistant against relative motion due to jostling and other vibrations occurring during normal shipping and handling to prevent premature inadvertent axial movement of the threaded fastener member 14 relative to sleeve 12 before installation to provide advantages to be described later.

As shown in FIG. 3, the shank has a length and the groove is positioned such that the point 32 of the fastener member 14 is in the central aperture and axially retained within the axial confines of the central aperture 15 of sleeve 12.

As shown in FIG. 3, the final assembly installation commences when the sleeve 12 is positioned within an aperture 42 through a first assembly member 40, for example an oil pan or an intake manifold that abuts against a second assembly member 50, for example an engine block. The sleeve length under the collar is the same length as the thickness of the first assembly member 40 between its surfaces 41 and 43. The position of fastener 14 with respect to the sleeve is unchanged from the position relative to the sleeve shown in FIG. 1. The point 32 remains recessed within the confines of the sleeve to prevent the point 32 from scratching any part of assembly member 50. This recess of the point 32 becomes important when the engine block or other second assembly member 50 is made from a softer material such as aluminum and needs to remain scratch free from inadvertent engagement with point 32.

It should also be noted that an optional sealing gasket or other settable seal 54 may be interposed between the first and second assembly members. The thickness of seal 54 is exaggerated in the FIGS. 3 and 4 to be clearly shown. When such a seal is used the seal can be considered as part of the first assembly member 40 when determining the length of sleeve 12 such that the sleeve accordingly extends to pass also through the seal 52.

In this position shown in FIG. 3, the clearance 44 shown between the threaded portion 28 and the inner wall 46 of sleeve aperture can provide lateral motion of the fastener about the aperture 15. The aperture 15 is preferably circular in cross section and the clearance 44 provides lateral motion an any direction 360 degrees about the axis of aperture 15. The clearance between tab 20 and shank 14, particularly the non thread body 26 which is necked down relative to the threaded portion 28 allows for lateral movement when the bolt is deliberately moved in a lateral motion. This lateral motion of fastener member 14 becomes important when the aperture 40 of the first member 42 may be slightly misaligned due to manufacturing tolerances from a threaded hole 56 within the second assembly member 50 and the fastener member 14 needs to be laterally moved to correctly engage the threaded hole 56.

Referring now to FIG. 4, when fully installed the threaded fastener member 14 is axially pushed or driven such that point 32 enters the threaded hole 56 and the drive head 22 is rotated, usually by a drive tool (not shown) to threadedly engage into hole 56 and fasten the two assembly members 40 and 50 together. The depth of threaded hole 56 is sufficient deep to receive and fully install the threaded fastener element 14 with first assembly member 40.

The collar 16 is interposed between the bearing surface 60 of the head 22 and the exposed surface 41 of first assembly member 40 and helps spread the compressive force about the first assembly member to help prevent excessive setting forces from being exerted onto assembly member 40 near and about the aperture 42. The length of the main portion 18 of the sleeve 12 applies a hard stop to the compressive forces and also prevents excessive compressive forces from deforming the first assembly member 40 and also from excessively deforming the optional gasket 54 between the first and second assembly members.

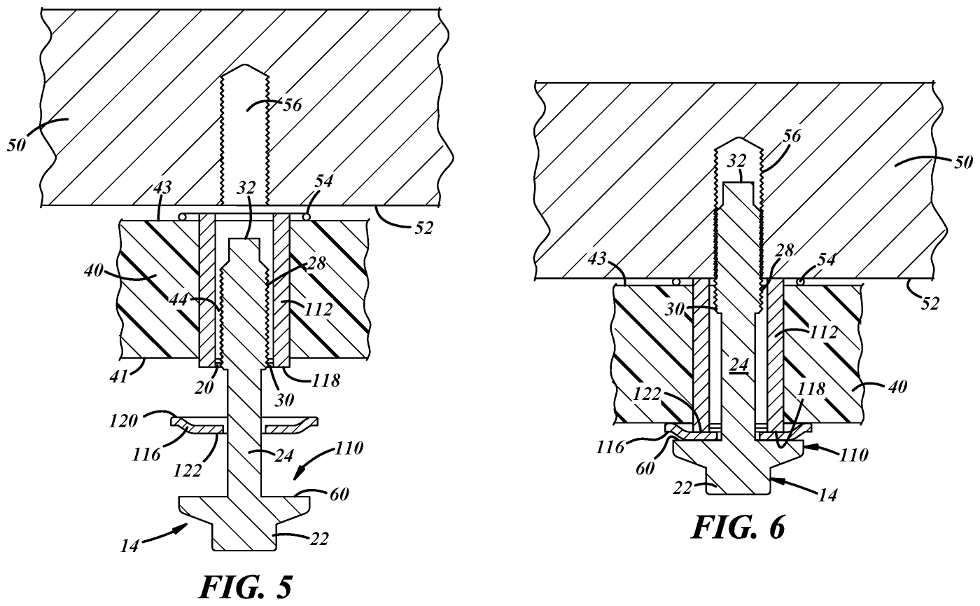

Referring now to FIGS. 5 and 6, a second embodiment of a compression limiter fastener element 110 is disclosed. Parts and portions that remain unchanged from the first embodiment are illustrated with similar numerals. In this embodiment, the sleeve 112 substitutes the collar for a spring member 116 that is interposed between the sleeve 112 and bearing surface 60. The spring member 116 has its center portion 122 surrounding shank 24 of threaded fastener member 14 and abuts against proximate end 118 of sleeve 112 which is positioned above exposed surface 41. An outer perimeter 120 is contoured toward the first assembly member 40 to abut against the exposed surface 41. The sleeve 112 extends to the opposite surface 43 of first member 40.

The end of sleeve 112 has tabs 20 to engage the threaded portion 28 or groove 30 in the same fashion as the first embodiment.

When the compression limiter fastener assembly 110 is installed as shown in FIG. 6, the bearing surface 60 pushes against spring member 116. The spring member 116 provides a greater rotation for the threaded fastener without drastically changing the compressive forces exerted between the first and second assembly members 40 and 50. This provides for a compressive force that is great enough to prevent separation of the parts but small enough to prevent permanent deformation or even cracking to the first assembly member to gasket 54. This constant spring load becomes even more critical when the gasket is a rubber gasket 54 such as one often found between an intake manifold and engine block. The rubber gasket 54 has a need to limit the compressive load exerted thereon to prevent damage or destruction.

The compressive limiters 10, 110 are able to compensate for variations in thickness of the first assembly member 40. It is also preferable that the sleeves 12 and 112 and the threaded fastener can be manufactured via cold forming to accommodate different hole sizes as demanded by various manufacturers. Furthermore, by having the fastener member 14 preset and captive in the sleeve as above described protects the threads against damage, prevents the point from scratching or damaging other parts, and presets the axial position of the drive head.

Variations and modifications are possible without departing from the scope and spirit of the present invention as defined by the appended claims.

I claim:

1. A compression limiter fastener assembly for assembling a first assembly member to second assembly member, said compression limiter fastener assembly comprising;
a fastener element having a drive head for engaging a drive tool for actuating fastening of the fastener element and a shank extending from said drive head to a point section having a body portion that is non threaded and proximate said drive head and a threaded portion positioned at a distal portion of said shank such that said body portion is interposed between said drive head and said threaded portion;
a sleeve element having a tubular section with a bore there through sized to surround said threaded portion and said body portion with clearance about both the threaded portion and body portion to allow said shank to be laterally moveable in said bore;
at least one tab radially inwardly extending to engage said shank such that said threaded section and point section are axially within the confines of said bore within the axial extent of said sleeve element until installation of said fastener element to said first and second assembly member;
said sleeve being constructed to fit within a hole of the first assembly member and being axially dimensioned to fully extend through the hole in said first assembly member to function as a compression limiter for said first assembly member;
said at least one tab being disengageable from said shank to release said shank upon sufficient axial force to allow said threaded section to move through said bore and engage a threaded hole in said second assembly member; and
a load distribution element being located between said drive head and said first assembly member to distribute compressive loads from said drive head to said first assembly member.

2. A compression limiter fastener assembly as defined in claim 1 further comprising;
said load distribution element being a spring loaded member element seated under a bearing surface of said drive head.

3. A compression limiter fastener assembly as defined in claim 1 further comprising;
said load distribution element being a collar integrally formed with said sleeve and extending radially outwardly at one end of said sleeve element to engage a bearing surface of said drive head.

4. A compression limiter fastener assembly as defined in claim 1 further comprising;
said sleeve member and at least one tab being made from a metal wherein said tabs are integrally formed with said sleeve from a punch operation; and
said at least one tab being flexible to release said shank upon sufficiently large axial force.

5. A compression limiter fastener assembly as defined in claim 1 further comprising;
said sleeve member and at least one tab being made from a metal wherein said at least one tab is integrally formed with said sleeve from a punch operation;
at least one tab being a plurality of tabs that are equally circumferentially spaced about said sleeve.

6. A compression limiter fastener assembly as defined in claim 1 further comprising;
said at least one tab engaging one of said threaded section or a groove in said shank for retaining the axial position of said shank relative to said sleeve.

7. A compression limiter fastener assembly as defined in claim 6 further comprising;
said shank having a groove positioned between said drive head and said threaded portion for receiving said at least one tab to retain the shank axially fixed relative to said sleeve.
